(19) United States
(12) Patent Application Publication
(10) Pub. No.: US 2019/0130314 A1
(43) Pub. Date: May 2, 2019

(54) APPARATUS, MANAGEMENT SYSTEM, AND NON-TRANSITORY COMPUTER READABLE MEDIUM

(71) Applicant: FUJI XEROX CO., LTD., TOKYO (JP)

(72) Inventor: Takatoshi BABA, Kanagawa (JP)

(73) Assignee: FUJI XEROX CO., LTD., TOKYO (JP)

(21) Appl. No.: 16/104,945

(22) Filed: Aug. 19, 2018

(30) Foreign Application Priority Data
Oct. 26, 2017 (JP) 2017-207328

(51) Int. Cl. G06Q 10/02; G06Q 10/10

(52) U.S. Cl. CPC G06Q 10/02; G06Q 10/1093

(57) ABSTRACT

An apparatus includes a presenter and a receiver. The presenter presents options of spaces to be used by plural subject users on a screen operated by an operator. The operator reserves a space for each of the subject users. An option is presented in accordance with a position linked to each of the subject users. The receiver receives a reservation made for a space by the operator for each of the subject users.

### CROSS-REFERENCE TO RELATED APPLICATIONS

This application is based on and claims priority under 35 USC 119 from Japanese Patent Application No. 2017-207328 filed Oct. 26, 2017.

### BACKGROUND

### (i) Technical Field

The present invention relates to an apparatus, a management system, and a non-transitory computer readable medium.

### (ii) Related Art

Services for providing the use of a space to a reservation holder are available.

### SUMMARY

According to an aspect of the invention, there is provided an apparatus including a presenter and a receiver. The presenter presents options of spaces to be used by plural subject users on a screen operated by an operator. The operator reserves a space for each of the subject users. An option is presented in accordance with a position linked to each of the subject users. The receiver receives a reservation made for a space by the operator for each of the subject users.

### BRIEF DESCRIPTION OF THE DRAWINGS

Exemplary embodiments of the present invention will be described in detail based on the following figures, wherein:

FIG. 1 schematically illustrates an example of the overall configuration of a management system;

FIG. 2 is an external view of an example of the configuration of a space to be rented to a user;

FIG. 3 is a block diagram illustrating an example of the hardware configuration of a user terminal;

FIG. 4 is a block diagram illustrating an example of the hardware configuration of a server forming the management system;

FIG. 5 is a block diagram illustrating an example of the configuration of a space which forms the management system;

FIG. 6 is a block diagram illustrating an example of the software configuration of a reservation management server;

FIGS. 7A through 7D illustrate examples of the relationships between operators and subject users;

FIG. 8 illustrates an example of the disposition of spaces in a real space;

FIG. 9 is a flowchart illustrating an example of a control operation executed by a reservation controller;

FIG. 10 illustrates an example of a screen for a group chat;

FIG. 11 illustrates an example of a screen displayed on a user terminal operated by an operator;

FIG. 12 illustrates a presentation example of an option spot for subject user A;

FIG. 13 illustrates another presentation example of an option spot for subject user A;

FIG. 14 illustrates another presentation example of option spots for subject user A;

FIG. 15 illustrates a presentation example of option spots for subject user B;

FIG. 16 illustrates a display example of a reservation-request receive screen which opens when operator C has selected a specific location;

FIG. 17 illustrates a display example of a guide screen which is displayed when a reserve button is clicked;

FIG. 18 illustrates an example of a case in which operator C selects and reserves a space at a location with a cursor;

FIG. 19 illustrates an example of a case in which multiple spaces are reserved for one subject user;

FIG. 20 illustrates a display example of a screen in which reservation areas are independently displayed for individual subject users;

FIG. 21A illustrates a display example of a screen for making a reservation for subject user A;

FIG. 21B illustrates a display example of a screen for making a reservation for subject user B; and

FIG. 22 schematically illustrates another example of the configuration of a management system.

### DETAILED DESCRIPTION

Exemplary embodiments of the invention will be described below with reference to the accompanying drawings.

### EXEMPLARY EMBODIMENT

### [Overall Configuration of Management System]

Due to the increased communication speed and smaller communication terminals, users can now access various items of information even outside the office. On the other hand, however, business conversations and information are highly confidential, and quiet and high-security environments are desirably provided.

In this exemplary embodiment, a management system for providing spaces that satisfy such a demand will be described. Spaces, which will be described below, are not restricted for business use, but may also be for personal use.

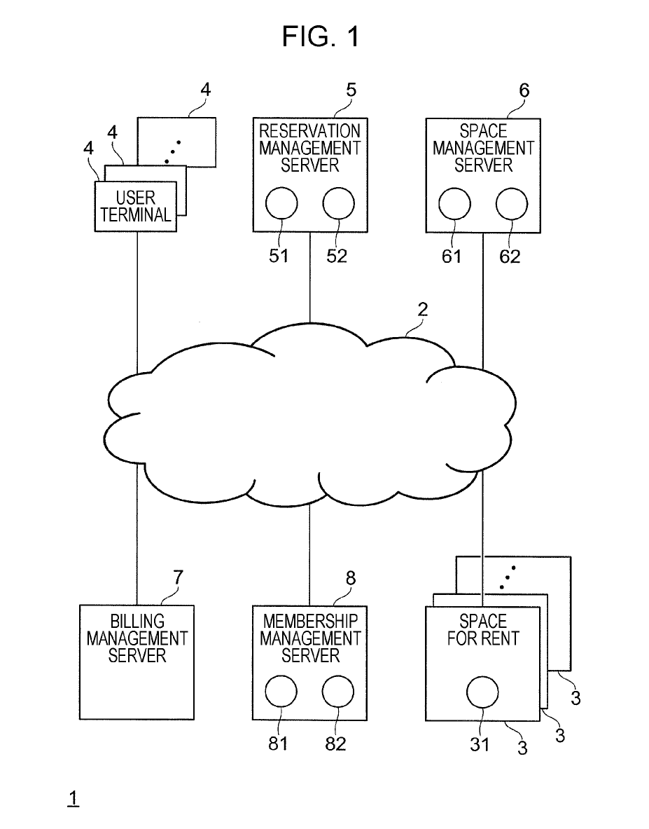

FIG. 1 schematically illustrates an example of the overall configuration of a management system 1.

As shown in FIG. 1, the management system 1 is constituted by various terminals connected to a cloud network 2.

In the example in FIG. 1, the management system 1 includes multiple spaces 3 for rent, multiple user terminals 4, a reservation management server 5, a space management server 6, a billing management server 7, and a membership management server 8. The spaces 3 for rent are spaces to be rented on a time basis. Hereinafter, the spaces 3 for rent may simply be called the spaces 3. The user terminals 4 are carried by individual users using the spaces 3. The reservation management server 5 manages reservations for the spaces 3. The space management server 6 manages the usage statuses of the individual spaces 3. The billing management server 7 bills users for the use of the spaces 3. The membership management server 8 manages information concerning members entitled to use the spaces 3.

The spaces 3 are available twenty-four hours a day, seven days a week (24/7), except for the time reserved for maintenance, for example.

In the management system 1 shown in FIG. 1, one server is provided for one purpose (function). Alternatively, plural servers may be provided for one purpose (function). Conversely, one server may be provided for multiple purposes (functions).

Renting services for the spaces 3 may be provided by one business operator or plural business operators. For example, different business operators may separately conduct management concerning reservations, access to and usage statuses of the spaces 3, billing for the use of the spaces 3, and members registered as users. Alternatively, multiple business operators may conduct management concerning one purpose (function) collaboratively.

Plural servers may be provided for one purpose (function). If a single business operator provides plural servers for one purpose (function) or provides plural servers for multiple purposes (functions), the plural servers are connected to each other via an intranet.

The spaces 3 may be provided by a single business operator or plural business operators.

The management system 1 may be implemented as an aggregation of services provided by plural business operators.

In this exemplary embodiment, a digital key is used for locking and unlocking a space 3. A digital key is stored in a user terminal 4 or an integrated circuit (IC) card which supports near field communication (NFC) (not shown). If a user terminal 4 is used as a digital key, a digital key is provided from the reservation management server 5 to the user terminal 4 after a reservation is confirmed. If an IC card is used as a digital key, an IC card having a digital key recorded thereon is distributed from the reservation management server 5 to a user terminal 4 after a reservation is confirmed.

The use of a digital key makes it possible to freely determine an effective time period for which a space 3 can be locked and unlocked. Multiple digital keys for using one space 3 for the same time period may be issued.

Alternatively, multiple physical keys may be provided according to the reserved time to lock and unlock a space 3. User authentication may alternatively be conducted instead of the use of a key or as a function for supporting the use of a digital key or a physical key.

The reservation management server 5 manages a registration list 51 and a reservation list 52. In the registration list 51, vacancies for spaces 3 are registered. The reservation management server 5 manages the allocation of reservation holders to the spaces 3 by using the reservation list 52.

In this exemplary embodiment, the reservation management server 5 receives reservation requests for the spaces 3 24/7, except for the time reserved for maintenance, for example. The reservation management server 5 also issues digital keys to the user terminals 4 and conducts authentication if necessary. The space management server 6 may alternatively conduct authentication.

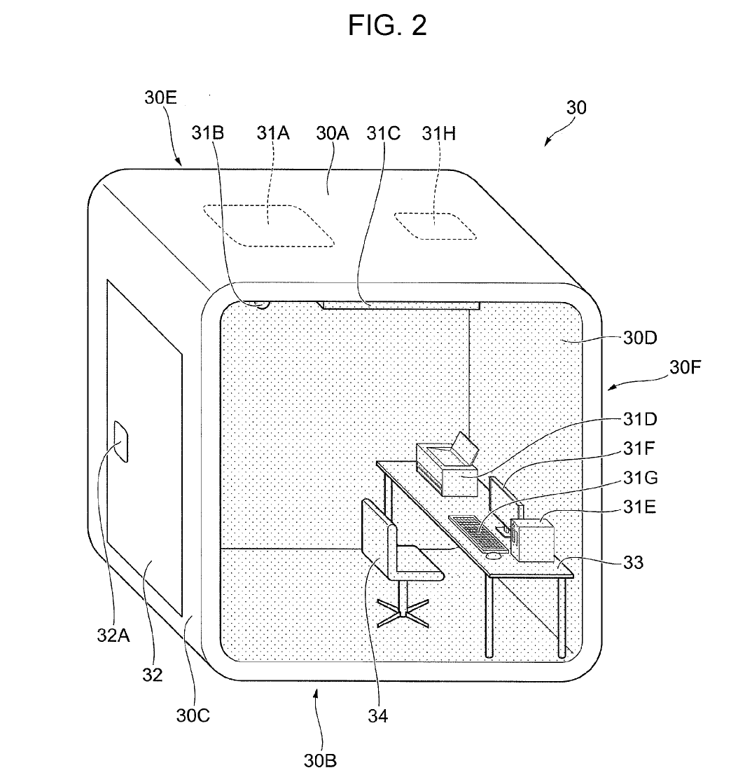

The space management server 6 manages information 61 concerning access to the individual spaces 3 and information 62 concerning the usage statuses of the individual spaces 3. The space management server 6 also serves the function of communicating with an authentication unit 32A (see FIG. 2) disposed in a space 3 to decide whether to permit a user to enter this space 3. When conducting authentication, the space management server 6 communicates with the reservation management server 5.

The space management server 6 also serves the function of collecting information from various devices 31 disposed in a space 3 and controlling the various devices 31.

The space management server 6 is connected to the cloud network 2 in FIG. 1. However, some or all of the functions of the space management server 6 may be integrated in a space 3.

The billing management server 7 serves the function of billing an individual member (may be a natural person (individual) or a legal person (enterprise)) based on reservation information, user information, information concerning access to a space 3. The billing management server 7 obtains reservation information from the reservation management server 5, information concerning access to a space 3 from the space management server 6, and membership information from the membership management server 8.

The membership management server 8 manages information concerning registered members and information concerning users. If a member is an individual person, the member is a user using a space 3. If a member is an enterprise, individual users are registered and managed according to the member. In this exemplary embodiment, the schedules of individual members are also registered in the membership management server 8.

FIG. 2 is an external view of an example of the configuration of a space 3 to be rented to a user.

In this exemplary embodiment, the spaces 3 are disposed indoors and outdoors, such as in station buildings, airports, office buildings, commercial complexes, for example, restaurants and department stores, banks, libraries, art galleries, museums, public institutions and facilities, passageways, and parks.

In this exemplary embodiment, a soundproof, small room is assumed as a space 3. In this sense, the space 3 is an example of a closed space. In this exemplary embodiment, however, “closed” does not mean “sealed”, but is used in the sense of a space having a practical soundproof function. Openings and gaps, such as vent holes and small windows, may be provided in part of a skeleton 30 forming a space 3.

The skeleton 30 includes a ceiling 30A, a floor 30B, a wall 30C to which a door 32 is fixed, two walls 30D and 30E at both sides of the wall 30C, and a wall 30F opposite the door 32.

In this exemplary embodiment, a single hinged door is assumed as the door 32. In the single hinged door, a single door member is opened and closed such that it draws an arc. However, the door 32 may be a double hinged door having two door members.

The door 32 may be a sliding door. The sliding door may be a single sliding door in which one door member slides, a multiple sliding door set in which two or more door members slide in opposite directions on different rails, or a separate double sliding door set in which one door member slides to the left and the other door member slides to the right.

The door 32 may be a folding door in which a pair of door members connected by a hinge opens to fold back. The folding door has a single type which opens to one side and a double type which opens to two sides.

The door 32 may be a special door, such as a partition door or a pocket door which is withdrawn into a wall when it is not used.

The door 32 may be an inward opening type or an outward opening type.

In this exemplary embodiment, the walls 30D and 30E are partly constituted by a light-transmitting member, such as glass and acrylic resin, for example.

The structure, material, or processing to implement a blind function may be utilized for at least part of the walls 30D and 30E. The blind function makes it difficult to see the inside of the space 3 from the outside or to reduce the visibility through the walls 30D and 30E.

The material of the walls 30D and 30E may be a translucent member or a member with small scratches on its surface so as to cause light to scatter. A film-like member having a similar function may be attached to the walls 30D and 30E. The film-like member may be a liquid crystal film that can electrically switch between a transparent state and an opaque state or a polarizing film that can electrically control the luminous transmittance.

A structure or a member for a blind function may be provided separately. The walls 30D and 30E, as well as the other surfaces, may be made of a member that does not transmit light. Conversely, among the elements forming the skeleton 30, three or more surfaces may be made of a transparent or translucent member.

The number of users using a space 3 is largely determined by the volume of this space 3. Basically, in this exemplary embodiment, a private room for one person is assumed as a space 3. However, the space 3 may be a large room for accommodating a large group of people. A large room may be formed as one room, or it may be formed by interconnecting spaces 3 by removing one of or both of the walls 30D and 30E of each space 3.

A private room is not necessarily for only one person, and may be used for a few people, such as two or three people.

The configuration and structure of the skeleton 30 forming an individual space 3, and facilities to be provided by the space 3 and their performance may be determined as desired.

In this exemplary embodiment, one desk 33 and one chair 34 are disposed within the skeleton 30. On the desk 33, a printer 31D, a computer 31E, a display device 31F, and an input device 31G, which are examples of the devices 31, are placed. To protect user information, data and history information stored in the computer 31E are all deleted under the control of the system after the use of the space 3.

As the other devices 31, an air conditioner 31A, a human sensor 31B, a lighting fixture 31C used as indoor illumination, a control device 31H, and an authentication unit 32A are fixed. The control device 31H controls the operation of electronic devices including the devices 31.

The devices 31 are only examples of electronic devices. The printer 31D, the computer 31E, the display device 31F, and the input device 31G on the desk 33 may not necessarily be provided. In this case, a user uses its own computer or smartphone.

The entirety of the space 3 (including the skeleton 30) or the control device 31H is an example of an apparatus. The control device 31H is also an example of a controller.

Each of the user terminal 4, the reservation management server 5, the space management server 6, the billing management server 7, and the membership management server 8 is also an example of the apparatus.

The management system 1 is an example of a management system.

### [Configuration of Terminal]

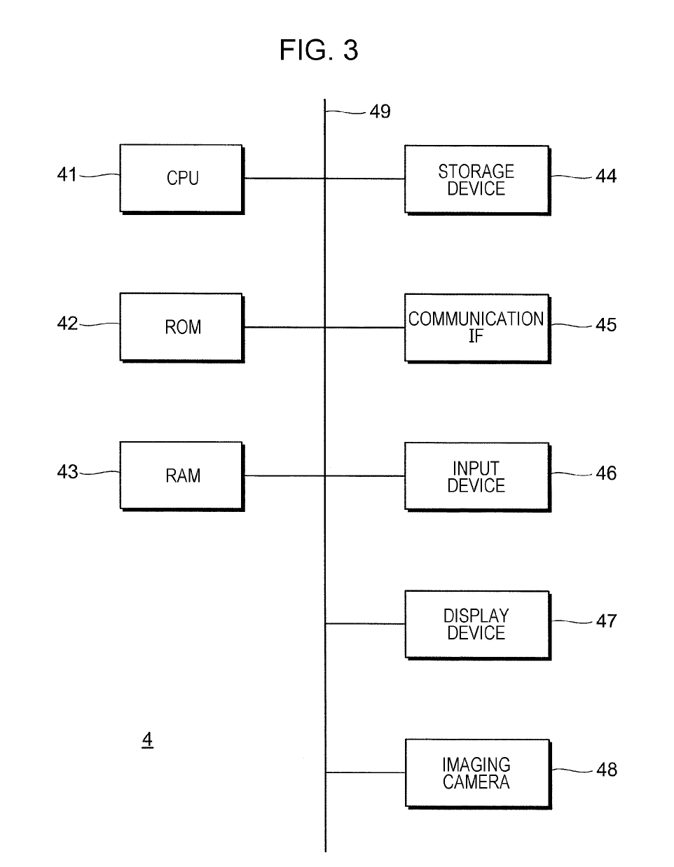

Examples of the configurations of the terminals forming the management system 1 will be discussed below with reference to FIGS. 3 through 5.

FIG. 3 is a block diagram illustrating an example of the hardware configuration of the user terminal 4.

In this exemplary embodiment, a smartphone is used as the user terminal 4.

The user terminal 4 includes a central processing unit (CPU) 41, a read only memory (ROM) 42, and a random access memory (RAM) 43. The CPU 41 provides various functions by executing firmware and application programs. The ROM 42 is a storage area in which firmware and basic input output system (BIOS) are stored. The RAM 43 is an area where a program is executed.

The user terminal 4 also includes a volatile storage device 44, a communication interface 45 (communication IF), an input device 46, such as a touchscreen, a display device 47, and an imaging camera 48. The storage device 44, which is a semiconductor memory, for example, stores downloaded application programs and a digital key, for example. The communication IF 45 is used for communicating with external devices. The display device 47 is used for displaying information.

The CPU 41 is connected to the devices forming the user terminal 4 via a bus 49.

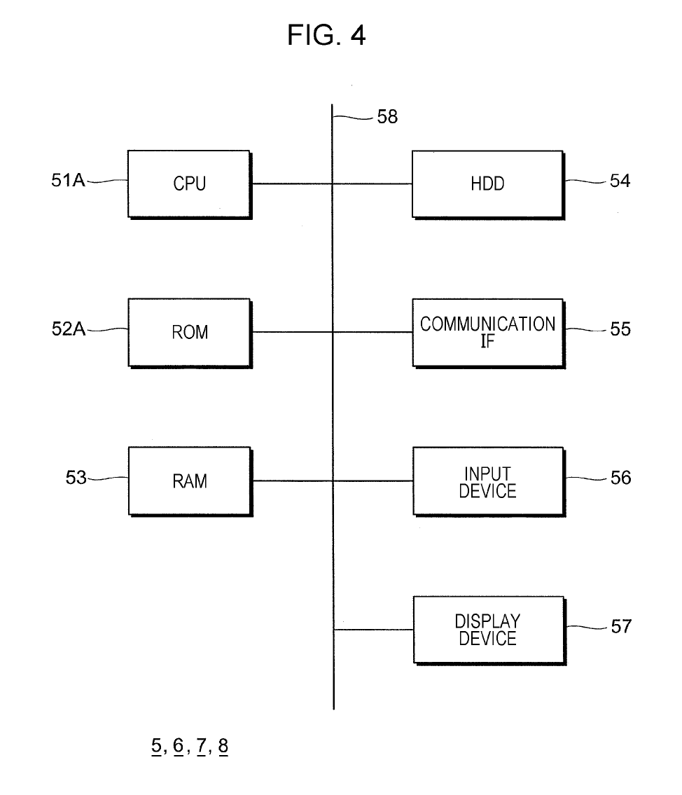

FIG. 4 is a block diagram illustrating an example of the hardware configuration of a server forming the management system 1.

The configuration of the reservation management server 5 is shown in FIG. 4 as a typical example of the server. The configurations of the other servers, that is, the space management server 6, the billing management server 7, and the membership management server 8, are similar to the configuration of the reservation management server 5.

The reservation management server 5 includes a CPU 51A, a ROM 52A, and a RAM 53. The CPU 51A provides various management functions by executing an operating system (OS) and application programs. The ROM 52A is a storage area in which an OS and a BIOS are stored. The RAM 53 is an area where a program is executed.

The reservation management server 5 also includes a volatile hard disk drive (HDD) 54, a communication IF 55, an input device 56, such as a keyboard, and a display device 57. The HDD 54 stores application programs and various items of management data for implementing the associated management functions. The communication IF 55 is used for communicating with external devices. The display device 57 is used for displaying information.

The CPU 51A is connected to the devices via a bus 58.

Each server is an example of a database for storing management data.

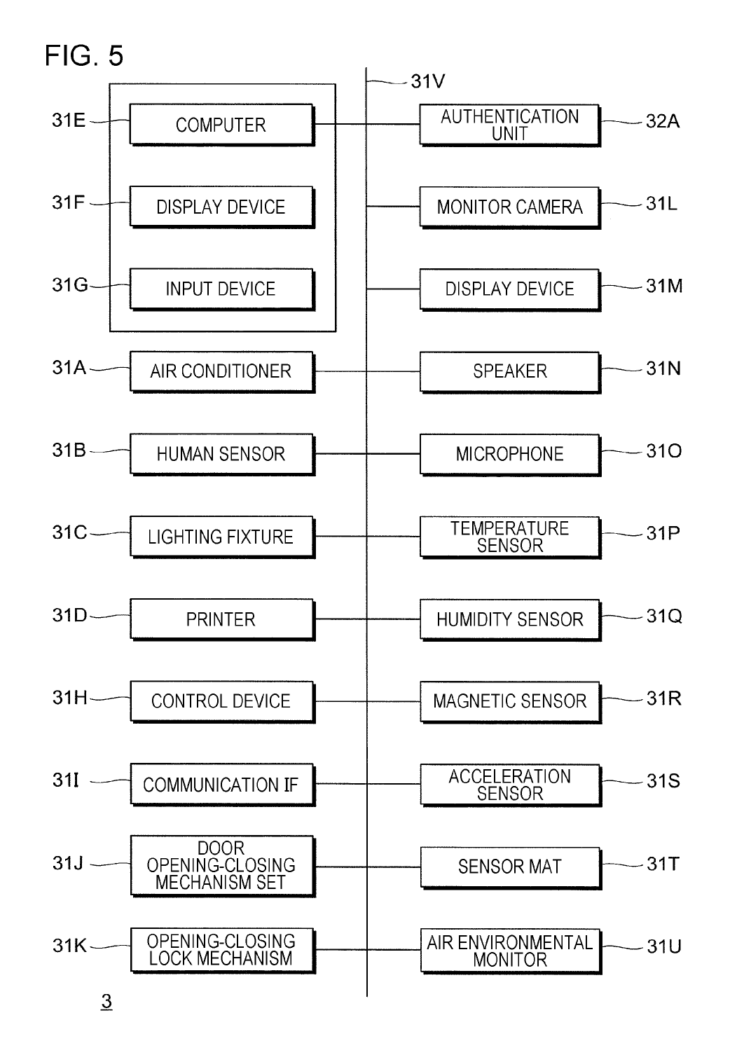

FIG. 5 is a block diagram illustrating an example of the configuration of a space 3 which forms the management system 1.

The space 3 includes an air conditioner 31A, a human sensor 31B, a lighting fixture 31C, a printer 31D, a computer 31E, a display device 31F, an input device 31G, a control device 31H, and an authentication unit 32A.

The air conditioner 31A is used for adjusting the temperature and humidity within the space 3 (room). A mechanism specially used for ventilation may be provided, together with or separately from the air conditioner 31A.

The human sensor 31B is a sensor for detecting people within the space 3. As the human sensor 31B, various types of sensors, such as a pyroelectric infrared human sensor that can detect the motion of people, and an image human sensor and a thermopile human sensor that can detect the number and position of people, are available. One or plural of these types of sensors are used according to the purpose of use.

The printer 31D, the computer 31E, the display device 31F, and the input device 31G are examples of information devices installed in the room for a user to operate. These information devices are connected to each other via a local area network (LAN) 31V, such as a LAN cable or a wireless LAN. If a user brings its own computer, the computer is connected to the LAN 31V. As the wireless LAN, WiFi (registered trademark) or Bluetooth (registered trademark) is used.

The control device 31H is a control computer that collects information from the devices 31 connected to the LAN 31V and also controls the operations of the individual devices 31. In some management systems 1, the control device 31H provides the functions of the space management server 6.

The authentication unit 32A is fixed to the door 32 of the space 3, for example. The authentication unit 32A is used for obtaining and sending and receiving information required for locking and unlocking the door 32. Authentication is conducted in the reservation management server 5, and an authentication result is only supplied to the authentication unit 32A. When authentication has succeeded, the authentication unit 32A unlocks the door 32. After unlocking the door 32, a user can open and close the door 32 to enter the space 3 (see FIG. 2).

The space 3 also includes a communication IF 311 for communicating with external devices. The communication IF 311 is connected to the cloud network 2 (see FIG. 1) to communicate with various servers.

The space 3 also includes a door opening-closing mechanism set 31J for mechanically controlling the opening and closing of the door 32. The door opening-closing mechanism set 31J includes a mechanism for driving the door 32 to open and close and a mechanism for adjusting the magnitude of a load required for a user to open and close the door 32.

The space 3 also includes an opening-closing lock mechanism 31K. The opening-closing lock mechanism 31K temporarily stops the opening and closing of the door 32. While the opening-closing lock mechanism 31K is in operation, at least the operation of closing the door 32 is temporarily stopped.

The space 3 also includes a monitor camera 31L for monitoring the motion of users indoors and outdoors. However, the monitor camera 31L may not necessarily be provided.

The space 3 also includes a display device 31M. In this exemplary embodiment, the display device 31M is disposed on the external side of the wall 30C to which the door 32 is fixed, and is used for a user to operate when entering the space 3 and also for providing information. The display device 31M is also used for a user using the space 3 and also for providing information.

The space 3 also includes a speaker 31N. The speaker 31N is used for supplying information to a user indoors and to people outdoors. The speaker 31N is an example of an informing device.

The space 3 also includes a microphone 310. The microphone 310 is used for collecting indoor sound.

The space 3 also includes a temperature sensor 31P. The temperature sensor 31P is used for measuring the indoor temperature.

The space 3 also includes a humidity sensor 31Q. The humidity sensor 31Q is used for measuring the indoor humidity.

The space 3 also includes a magnetic sensor 31R. The magnetic sensor 31R is attached to the door 32 to detect the opening or closing of the door 32 by sensing a magnetic force.

The space 3 also includes an acceleration sensor 31S. The acceleration sensor 31S is used for detecting the motion of an object.

The space 3 also includes a sensor mat 31T. The sensor mat 31T detects the weight of an object to visualize the time period for which a user has stayed in the space 3 or the congestion status of the space 3.

The space 3 also includes an air environmental monitor 31U. The air environmental monitor 31U, which detects constituents contained in air in the space 3, measures concentrations of PM2.5 and PM10, carbon dioxide, and volatile organic compounds. The air environmental monitor 31U may also measure the temperature and the humidity. The air environmental monitor 31U may not necessarily measure all of the above-described constituents or may measure other constituents. If the air environmental monitor 31U measures the temperature and the humidity, the provision of the temperature sensor 31P and the humidity sensor 31Q may be omitted.

### [Control Function]

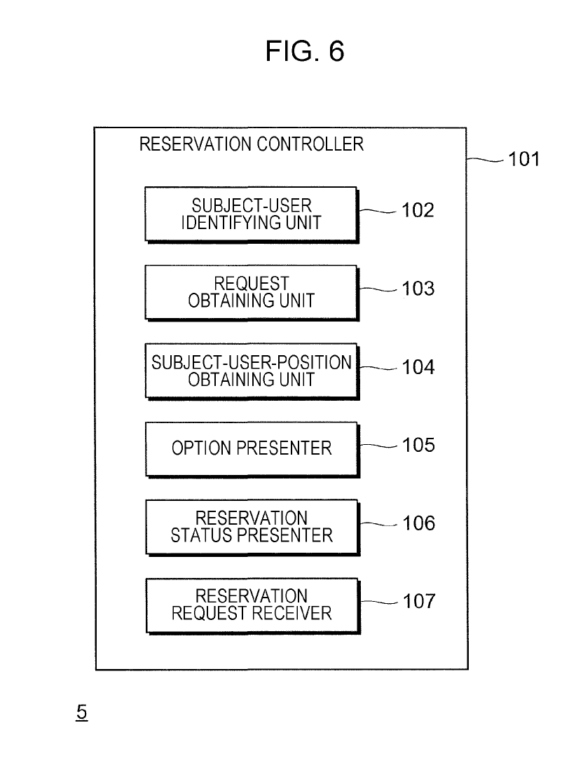

A control function implemented by one of the terminals forming the management system 1 (see FIG. 1) or by collaborative work of some of the terminals will be discussed below with reference to FIG. 6.

A description will be given of a case in which the control function is implemented by the reservation management server 5 alone.

FIG. 6 is a block diagram illustrating an example of the software configuration of the reservation management server 5.

The reservation management server 5 implements the corresponding functions by executing a program.

In this exemplary embodiment, the reservation management server 5 has the function of assisting a single operator in reserving multiple spaces 3 for plural subject users.

In this exemplary embodiment, this function is called a reservation controller 101. The reservation controller 101 is an example of a presenter and an example of a receiver.

The reservation controller 101 includes multiple functions.

More specifically, the reservation controller 101 includes a subject-user identifying unit 102, a request obtaining unit 103, a subject-user-position obtaining unit 104, an option presenter 105, a reservation status presenter 106, and a reservation request receiver 107. The subject-user identifying unit 102 identifies a subject user for which a reservation will be made. The request obtaining unit 103 obtains specific requests concerning reservations from individual subject users. The subject-user-position obtaining unit 104 obtains the positions of individual subject users. The option presenter 105 presents options for a reservation for individual subject users. The reservation status presenter 106 presents the reservation status of each space 3. The reservation request receiver 107 receives reservation requests from the operator.

The subject-user identifying unit 102 identifies a subject user by using information (such as the name or the employee ID number) concerning this subject user specified or input by the operator. The subject-user identifying unit 102 may identify a subject user based on participants or a dialog history in a group chat. In this exemplary embodiment, information to be used for identifying a subject user is specified or input by one operator.

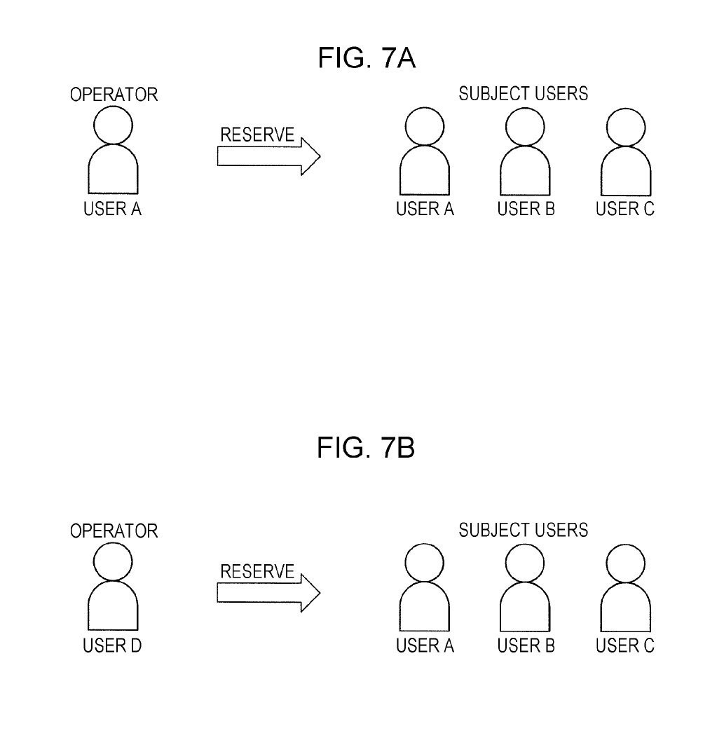

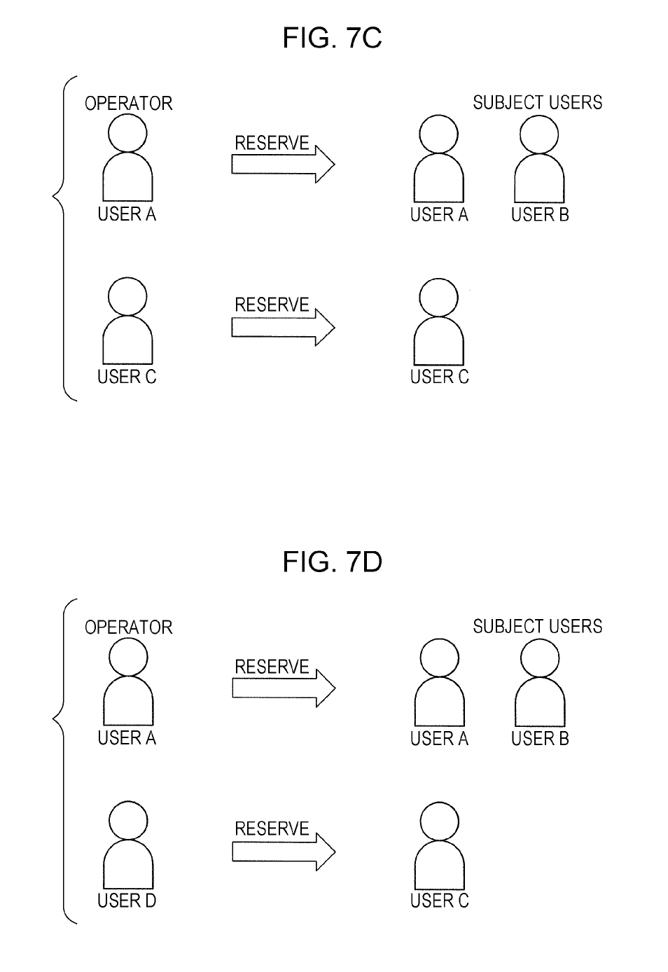

The relationships between operators and subject users will be discussed below with reference to FIGS. 7A through 7D.

FIGS. 7A through 7D illustrate examples of the relationships between operators and subject users. FIG. 7A shows a case in which one of the subject users is the operator. FIG. 7B shows a case in which a user different from the subject users is the operator. FIG. 7C shows a case in which one of the subject users is an operator to make a reservation for itself and also for another subject user, and the remaining subject user is also an operator to make a reservation for itself. FIG. 7D shows a case in which one of the subject users is an operator to make a reservation for itself and also for another subject user, and a user different from the subject users is an operator to make a reservation for the remaining subject user.

Specific requests obtained by the request obtaining unit 103 (see FIG. 6) may be concerned with a location, a time period, and required facilities. The request obtaining unit 103 may obtain specific requests based on information (such as individual schedules) registered in the membership management server 8 (see FIG. 1) or by analyzing a conversation in a business chat, for example. Alternatively, an operator may input requests received from the individual subject users. If a business chat is carried out in text, requests made by the individual subject users are identified by character recognition, and if a voice chat is conducted, requests are identified by voice recognition.

As position information to be obtained by the subject-user-position obtaining unit 104 (see FIG. 6), at least one of the current location of a subject user, a location requested by the subject user (hereinafter called a requested location), a location estimated from the schedule of the subject user (hereinafter called an estimated location) are used. As the current location of a subject user, information output from a global positioning system (GPS) receiver of the user terminal 4 (see FIG. 1), for example, may be used.

The requested location may be provided, not only by a specific place, but also by a range. The range is, for example, an area along railway line A, an area between station B and station C, and an area from a current location to DD building.

The option presenter 105 (see FIG. 6) displays spaces 3 in the neighborhood of the current location of a subject user or a requested location as options for a reservation on a screen operated by the operator.

In this case, “the neighborhood” is provided by a range from a certain start point within a predetermined distance.

For example, if a requested location is provided as a specific name of a place or a building, the option presenter 105 displays as options spaces 3 disposed inside a range extending around a specified location within a predetermined distance.

For example, if a requested location is provided as an area along a railway line or a road, the option presenter 105 displays as options spaces 3 disposed inside a range extending to both sides from the specified railway line or road within a predetermined distance.

If a requested location is provided as somewhere between two landmarks, the option presenter 105 displays as options spaces 3 disposed inside a range extending to both sides from a route connecting the two landmarks within a predetermined distance.

If a requested location is provided as a specific direction from one landmark, the option presenter 105 presents as options spaces 3 disposed inside a range extending to both sides from a route existing in the specific direction within a predetermined distance. In this case, by disregarding the path of the route, the option presenter 105 may display as options spaces 3 disposed inside a range extending to both sides from a straight line in the specific direction within a predetermined distance.

If the current location of a subject user and a requested location are different, it is desirable to narrow down spaces 3 selected as options in terms of the times required for the subject user to reach the spaces 3.

The reservation status presenter 106 (see FIG. 6) displays, on a screen operated by an operator, the reservation statuses of individual spaces 3 managed by the reservation management server 5 (see FIG. 1). The reservation status presenter 106 alternatively displays the overall reservation status in each location where one or multiple spaces 3 are disposed on a screen operated by an operator.

If a list of spaces 3 is displayed on a screen operated by the operator, the reservation status presenter 106 displays the reservation status in association with each space 3 or each location by using numeric values or different colors.

For example, if a map is displayed on a screen operated by the operator and symbols representing the disposition of spaces 3 are displayed on the map, the reservation status presenter 106 displays the individual symbols in different colors according to the reservation status.

When the overall reservation status is displayed according to the location, if a specific location is selected by the operator, the reservation status presenter 106 individually displays the reservation statuses of multiple spaces 3 disposed within this specific location.

The reservation request receiver 107 (see FIG. 6) receives reservation requests for spaces 3 for corresponding subject users from the operator. While an option is being presented to a certain operator, the reservation request receiver 107 does not receive reservation requests from the other operators, thereby avoiding the occurrence of double-booking.

When a reserve button is operated, the reservation request receiver 107 confirms a reservation made for an option. The reservation request receiver 107 may allow an operator to reserve multiple spaces 3 for one subject user. In this case, however, the reservation request receiver 107 cancels all reservations made for the spaces 3 by leaving a reservation for one space 3 in the end.

After reservations have been confirmed, the reservation request receiver 107 informs all the corresponding subject users that reservations have been confirmed. Confirmation information may be sent to the subject users separately or together. If confirmation information is sent to all the subject users together, it may be posted in a group chat, for example.

### [Examples of Control Operation]

Examples of the control operation implemented under the control of the reservation controller 101 (see FIG. 6) will be described below.

An example of the disposition of spaces 3 will first be discussed. The reservation controller 101 manages reservations for the spaces 3.

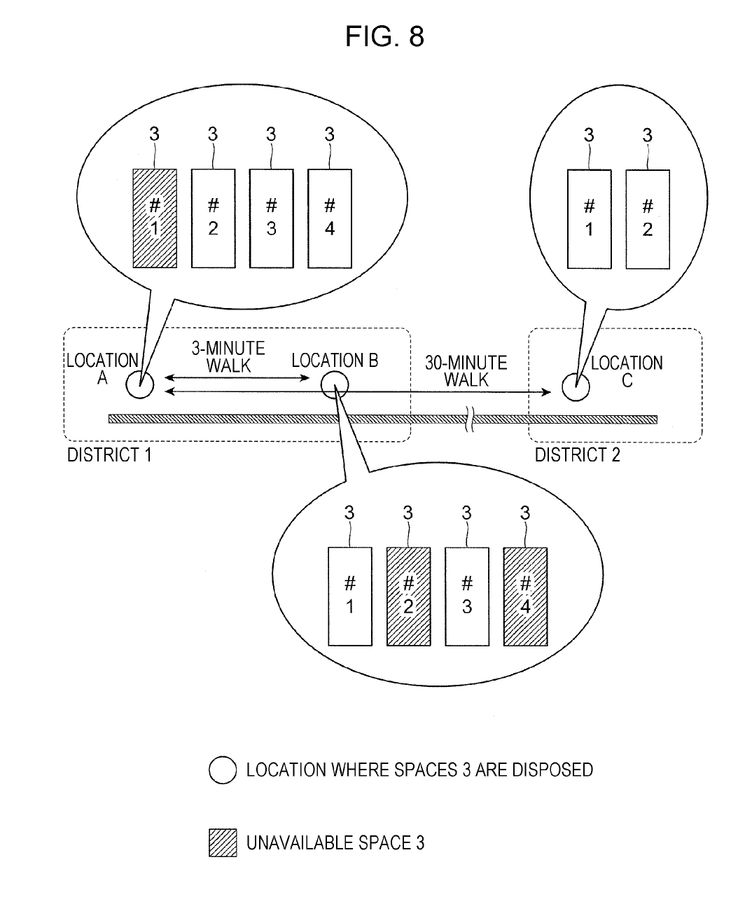

FIG. 8 illustrates an example of the disposition of spaces 3 in a real space.

FIG. 8 shows two areas managed as district 1 and district 2. The districts may be determined based on the administrative division or on another factor. The districts may alternatively be determined by using a building, such as a city hall or a department store, or a landmark as a start point.

In an individual district, one or plural locations are included. In the example in FIG. 8, location A and location B are included within district 1, while location C is included in district 2.

In each location, one or multiple spaces 3 are disposed. For example, four spaces 3 are disposed in location A, four spaces 3 are disposed in location B, and two spaces 3 are disposed in location C.

The individual spaces 3 are distinguished from each other by the name and the ID number indicated within the location.

Information concerning the districts, locations, and ID numbers is also used in the registration list 51 (see FIG. 1) and the reservation list 52 (see FIG. 1).

In FIG. 8, available spaces 3 and unavailable spaces 3 are displayed such that they can be distinguished from each other.

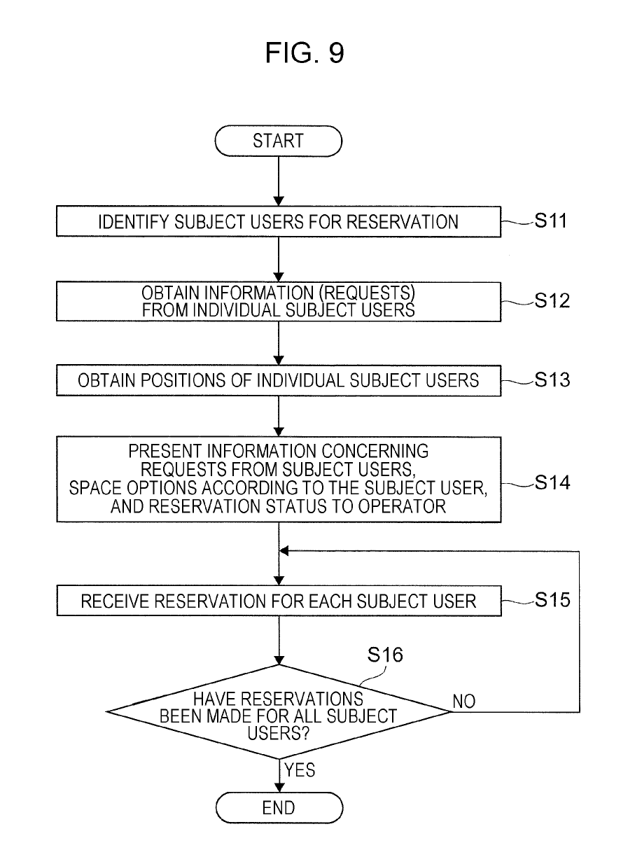

FIG. 9 is a flowchart illustrating an example of a control operation executed by the reservation controller 101.

In step S11, the reservation controller 101 identifies subject users for which reservations will be made. In this exemplary embodiment, a group chat is used for identifying subject users.

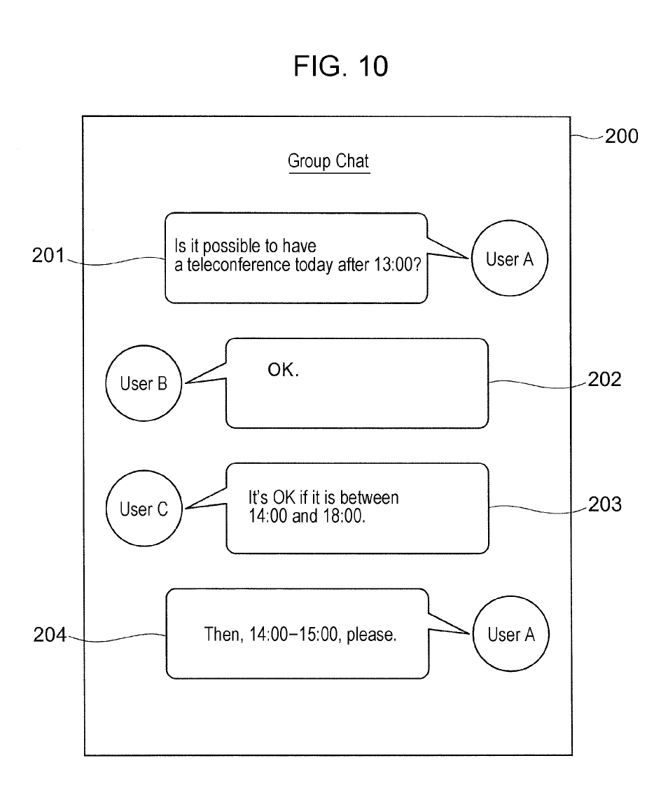

FIG. 10 illustrates an example of a screen for a group chat 200.

On the screen for the group chat 200, speech bubbles 201 through 204 are shown in chronological order. It is assumed that user A and user B are outside the office, while user C is in the office. More specifically, user A first says “Is it possible to have a teleconference today after 13:00?”, then, user B says “OK.”, and then, user C says “It's OK if it's between 14:00 and 18:00”. Then, user A says “Then, 14:00-15:00, please”.

From this conversation, the reservation controller 101 determines that subject users are three people, that is, user A, user B, and user C, based on information concerning the speakers in the group chat 200.

It is assumed that user C in the office is an operator. User A, user B, and user C will be called subject users A, B, and C, respectively, while user C as the operator will be called operator C.

Then, in step S12, the reservation controller 101 obtains information (specific requests) concerning the individual subject users. In the example in FIG. 10, the reservation controller 101 extracts “after 13:00” and “14:00-15:00” as requests from subject user A, “after 13:00” as a request from subject user B, and “14:00-18:00” as a request from subject user C.

The reservation controller 101 extracts “14:00-15:00” as a time period that matches the requests from all the three subject users.

Subject user A has made a request “near W building” as a location, and subject user B has made a request “somewhere between station M and station P on line Y” as a location, though such requests are not shown in FIG. 10.

Then, in step S13, the reservation controller 101 obtains the positions of the individual subject users. The reservation controller 101 obtains a current location, a requested location, and an estimated location concerning each subject user. The current location of a subject user may be obtained from the terminal (that is, the user terminal 4) of the corresponding subject user which is being used for the group chat 200. The requested location may be obtained from the group chat 200. The estimated location may be estimated from the current location of a subject user and schedule information concerning this subject user. The estimated location is also estimated by using information concerning a transportation facility and the time taken to reach a destination. In this exemplary embodiment, the current location, requested location, and estimated location may also be collectively called option spots.

Then, in step S14, the reservation controller 101 presents information concerning requests from each subject user, options of spaces 3 for each subject user, and reservation status of each space 3 to operator C. This enables operator C to choose spaces 3 while checking the requests from the subject users.

In this exemplary embodiment, it is assumed that operator C will attend a teleconference in a meeting room in the office. Operator C reserves spaces 3 for two subject users A and B outside the office.

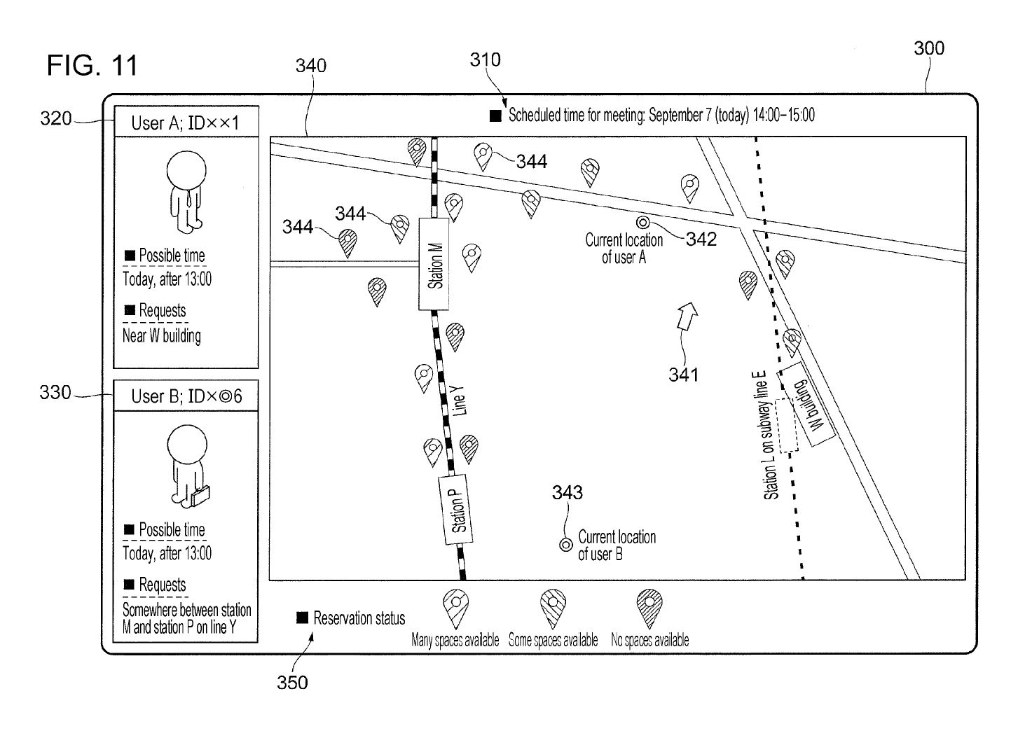

FIG. 11 illustrates an example of a screen 300 displayed on the user terminal 4 (see FIG. 1) operated by operator C.

FIG. 11 shows a case in which operator C reserves spaces 3 for two subject users A and B on the screen 300.

The screen 300 has regions 310 through 350. In the region 310, a time period for which spaces 3 will be reserved is displayed. In the region 320, requests (such as a time period and a location) from subject user A are displayed. In the region 330, requests (such as a time period and a location) from subject user B are displayed. In the region 340, information concerning the positions of subject user A and subject user B, locations of options for a reservation, and the individual spaces 3 are displayed. In the region 350, legends explaining the reservation status are indicated.

In the region 310, the time period obtained in step S12 (see FIG. 9), for example, is displayed. Operator C may be allowed to input a time period into the region 310 and to modify a displayed time period. The provision of the region 310 enables operator C to make reservations while checking the time period for which spaces 3 will be reserved. This avoids operator C from making input errors and saves operator C the trouble of checking the time period every time it makes a reservation.

In the regions 320 and 330, information concerning requests from subject user A and that from subject user B are displayed. Although information concerning two subject users A and B is only shown in FIG. 11, information concerning operator C, which is also a subject user, may also be displayed.

The reason why information concerning operator C is not displayed in FIG. 11 is that a meeting room in the office will be used and operator C is not required to reserve a space 3 for itself. In this manner, regarding information concerning subject users, operator C can select which information will be displayed on the screen 300.

In the region 320, regarding requests from subject user A, “today, after 13:00” is indicated as a time period and “near W building” is indicated as a location.

In the region 330, regarding requests from subject user B, “today, after 13:00” is indicated as a time period and “somewhere between station M and station P on line Y” is indicated as a location.

ID numbers for identifying subject users A and B, such as employee ID numbers, are also displayed.

In FIG. 11, in the region 340, the current locations of subject users A and B, spaces 3 near their current locations or option spots, and reservation statuses of the spaces 3 are displayed together with the landmarks on the map.

In the example in FIG. 11, the scale of the map is small enough for operator C to check information concerning subject user A and that concerning subject user B within the same screen 300. However, different screens may be provided for individual subject users. If the scale of a map is too small, the reservation status is difficult to check even if it is provided according to the location. A display example of different screens will be discussed later.

In the example in FIG. 11, as the landmarks on the map, line Y, station M and station P located on line Y, subway line E, station L on subway line E, major roads (indicated by the straight lines in FIG. 11), and W building, which is the principal building, are displayed.

In the region 340, a cursor 341, a double circle mark 342 indicating the current location of subject user A, and a double circle mark 343 indicating the current location of subject user B are indicated. Drop marks 344 represent the positions of locations where spaces 3 are disposed.

In FIG. 11, the reservation status is indicated by the density of the hatched portions of the drop marks 344. As the legends in the region 350 indicate, a higher density of the hatched portion of a drop mark 344 means that many reservations have been made and fewer spaces 3 are available, and a lower density of the hatched portion of a drop mark 344 means that few reservations have been made and more spaces 3 are available.

The reservation status indicated in the region 340 is that concerning the time period displayed in the region 310.

Although the reservation status is represented by three levels in FIG. 11, it may be represented by two or four or more levels. On the actual screen, the reservation status may be indicated according to a difference in the color.

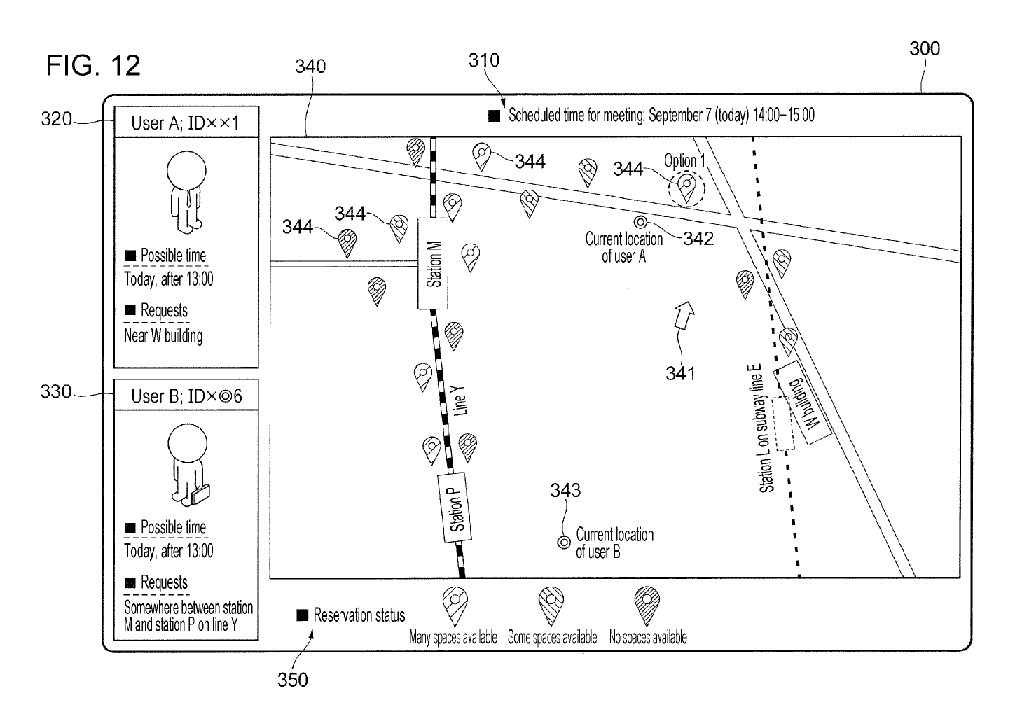

FIG. 12 illustrates a presentation example of an option spot for subject user A.

In FIG. 12, portions corresponding to those shown in FIG. 11 are designated by like reference numerals. In FIG. 12, a location in the neighborhood of the current location of subject user A (in the neighborhood of the double circle mark 342) is displayed as option 1. This enables operator C to identify that option 1 is an option for a reservation. The location at option 1 has many available spaces 3.

If many locations are displayed on the screen 300, operator C may find it difficult to recognize an option spot. An option spot is thus desirably displayed so that operator C can easily recognize it, for example, as option 1 shown in FIG. 12. Alternatively, an option spot may be surrounded by a broken line or be displayed with an increased brightness or in a larger size than the other locations.

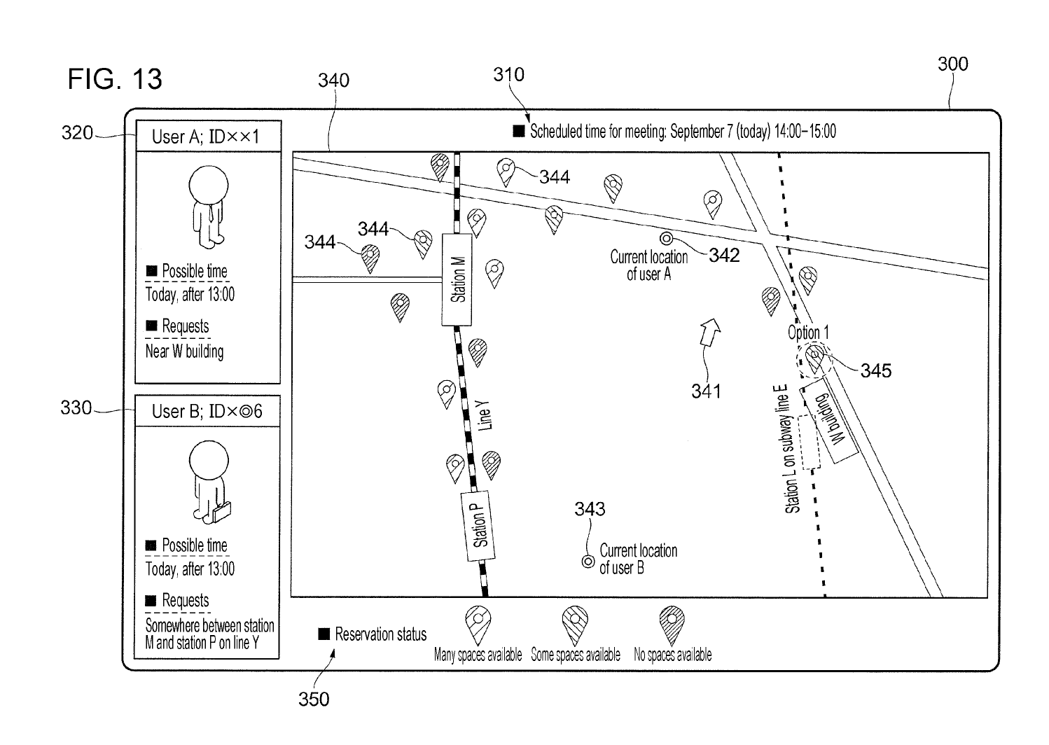

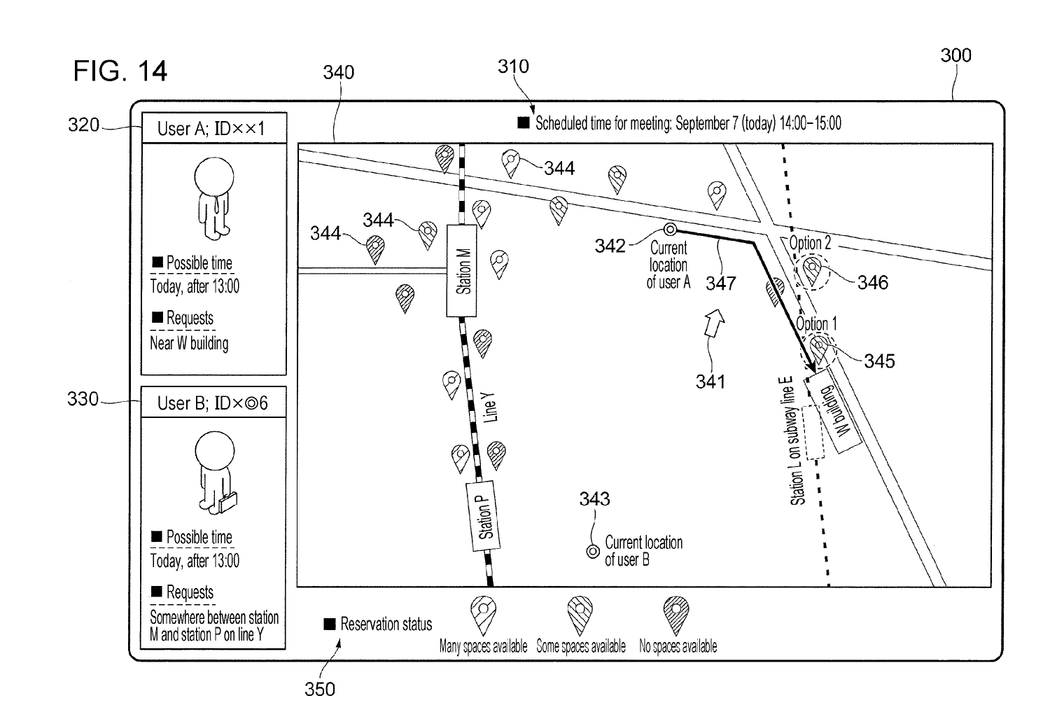

FIG. 13 illustrates another presentation example of an option spot for subject user A.

In FIG. 13, portions corresponding to those shown in FIG. 11 are designated by like reference numerals. In FIG. 13, a location 345 in the neighborhood of the requested location (W building) of subject user A is displayed as option 1. This enables operator C to identify that option 1 is an option for a reservation. The location 345 at option 1 has some available spaces 3.

FIG. 14 illustrates another presentation example of option spots (estimated locations) for subject user A.

In FIG. 14, portions corresponding to those shown in FIG. 11 are designated by like reference numerals. In FIG. 14, a route 347 from the current location of subject user A to the requested location (W building) is estimated, and two locations 345 and 346 positioned in the neighborhood of the route 347 are displayed as option 1 and option 2.

The route 347, which is estimated as a route to the requested location, is displayed in the region 340. However, the route 347 may not be displayed. Operator C may select whether to display the route 347.

Both of the locations 345 and 346 have some available spaces 3.

When presenting locations in the neighborhood of the route 347 to operator C as option spots, the reservation controller 101 determines option spots to be presented in terms of a route to a destination described in the schedule of subject user A, the time required to reach the destination, and a time period for which a space 3 will be reserved.

The display examples shown in FIGS. 12 through 14 may be switched by the operation of operator C. That is, operator C may be allowed to switch among a screen for presenting an option spot in the neighborhood of a current location of a subject user, a screen for presenting an option spot in the neighborhood of a requested location, and a screen for presenting an option spot in the neighborhood of a route to a destination of the subject user. This is effective when a space 3 to be reserved is not found on a specific screen.

If a space 3 to be reserved is not found in any of the screens, operator C may point and select a space 3 at a certain location with the cursor 341.

For the sake of representation, presentation examples of option spots for subject user A are shown in FIGS. 12 through 14. Option spots for subject user B may be presented to operator C similarly by the reservation controller 101.

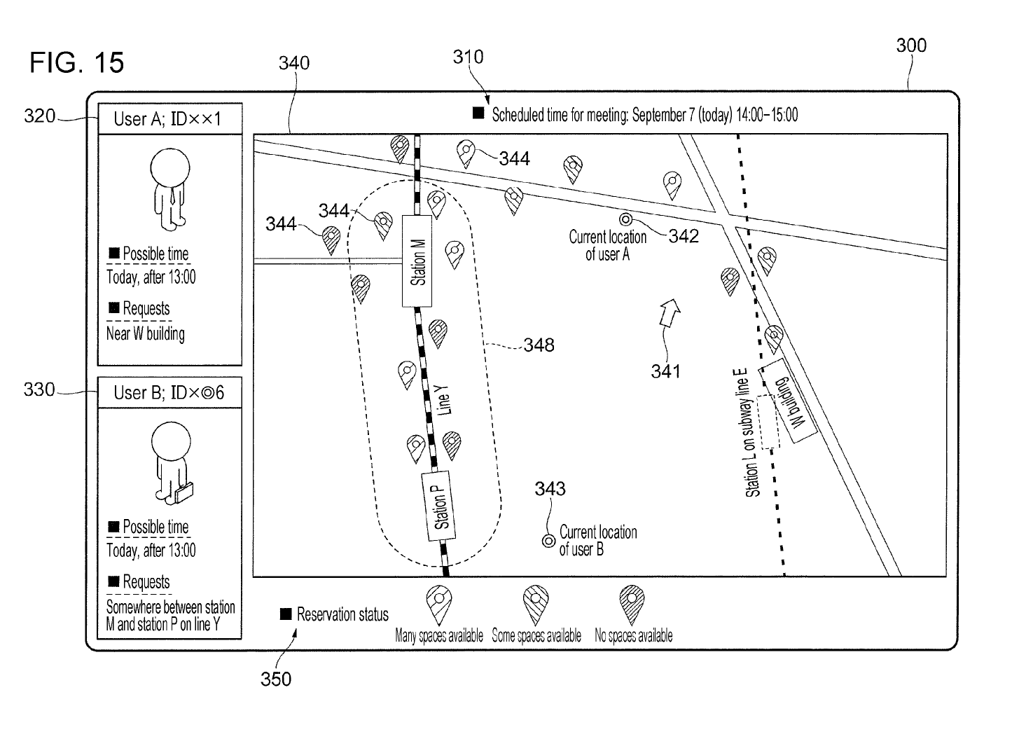

FIG. 15 illustrates a presentation example of option spots for subject user B.

In FIG. 15, portions corresponding to those shown in FIG. 11 are designated by like reference numerals. In FIG. 15, unlike for subject user A, a range 348 of an area requested by subject user B is displayed as an option. Plural locations positioned within the range 348 defined by the broken-line ellipse are options of spaces 3 to be reserved.

Referring back to FIG. 9, after presenting information in step S14, the reservation controller 101 receives a request for a reservation made by operator C for each subject user in step S15. Step S15 is repeated until the reservation controller 101 determines that reservations have been made for all the subject users in step S16 (until the result of step S16 becomes YES). While the result of step S16 is NO, the reservation controller 101 receives a request for a reservation.

The reservation controller 101 may determine that reservations have been made for all the subject users when a button (not shown) has been operated.

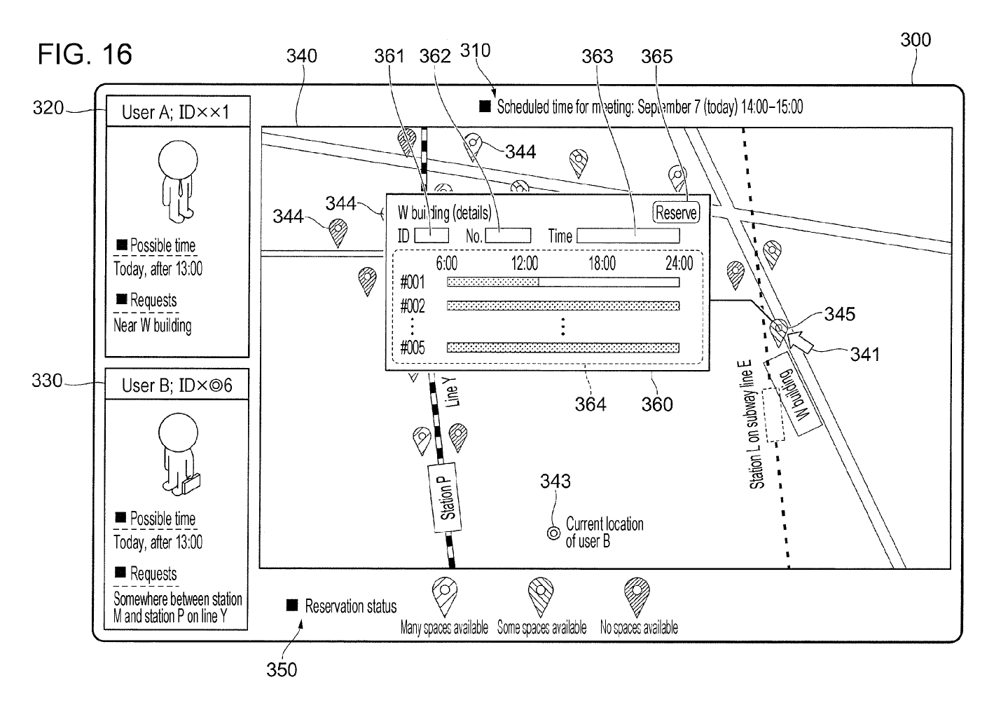

FIG. 16 illustrates a display example of a reservation-request receive screen 360 which opens when operator C has selected a specific location.

In FIG. 16, portions corresponding to those shown in FIG. 11 are designated by like reference numerals. In FIG. 16, the reservation-request receive screen 360 is displayed when operator C has clicked the location 345 in the neighborhood of W building with the cursor 341.

The reservation-request receive screen 360 includes input fields 361, 362, and 363, a region 364, and a button 365. In the input field 361, information for identifying a subject user is input. In the input field 362, information for identifying a space 3 to be reserved is input. In the input field 363, a time period for which a space 3 will be reserved is input. In the region 364, the reservation statuses of individual spaces 3 disposed in the location 345 are indicated. The button 365 is used for confirming a reservation.

In the example in FIG. 16, the space 3 identified by #001 is available.

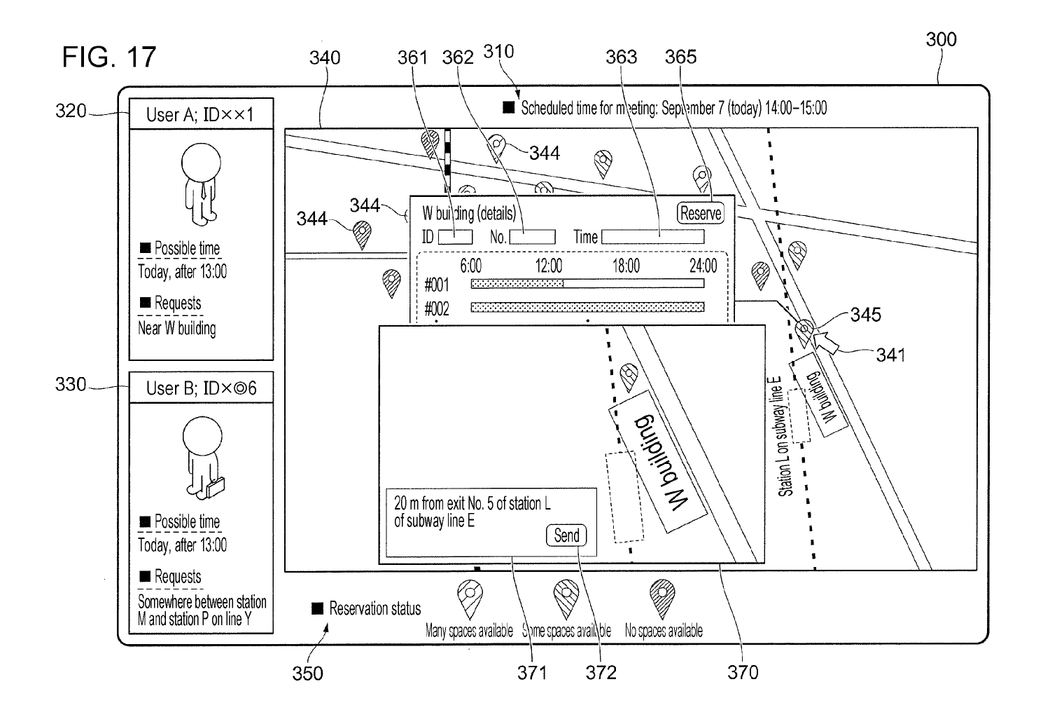

FIG. 17 illustrates a display example of a guide screen 370 which is displayed when the button 365 (see FIG. 16) is clicked.

In FIG. 17, portions corresponding to those shown in FIG. 11 are designated by like reference numerals. On the guide screen 370, an enlarged map of the neighboring area of the reserved location 345 is displayed. The guide screen 370 includes a guiding message 371 describing how to get to the location 345 and a send button 372. The send button 372 is used for sending the guide screen 370 to the user terminal 4 of the subject user for which a space 3 at the location 345 is reserved (subject user A in this case).

The guide screen 370 is an example of information for assisting a subject user in reaching a reserved space 3.

In the example in FIG. 17, the guiding message 371 shows that the location 345 where the reserved space 3 (#001) is disposed is at a point 20 m from exit No. 5 of station L on subway line E.

FIGS. 16 and 17 show an example of a case in which a reservation is made for a space 3 in the neighborhood of an option spot. An explanation will now be given of an example of a case in which no spaces 3 are available in the neighborhood of an option spot.

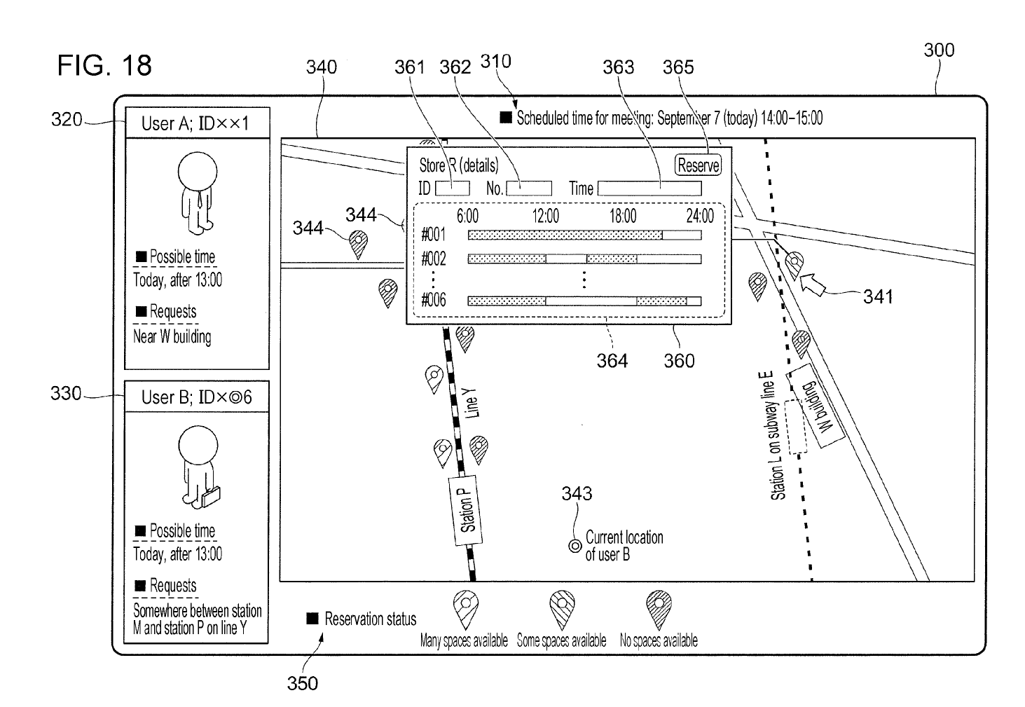

FIG. 18 illustrates an example of a case in which operator C selects and reserves a space 3 at a location with the cursor 341.

In FIG. 18, portions corresponding to those shown in FIG. 11 are designated by like reference numerals. FIG. 18 shows an example of a case in which no spaces 3 are available in the location 345 that matches a request made by subject user A, and the neighboring location 346 has been selected by operator C as an alternative to the location 345.

In FIG. 18, the space 3 identified by #006 is available from 12:00 to 18:00 and can be reserved from 14:00 to 15:00 for subject user A.

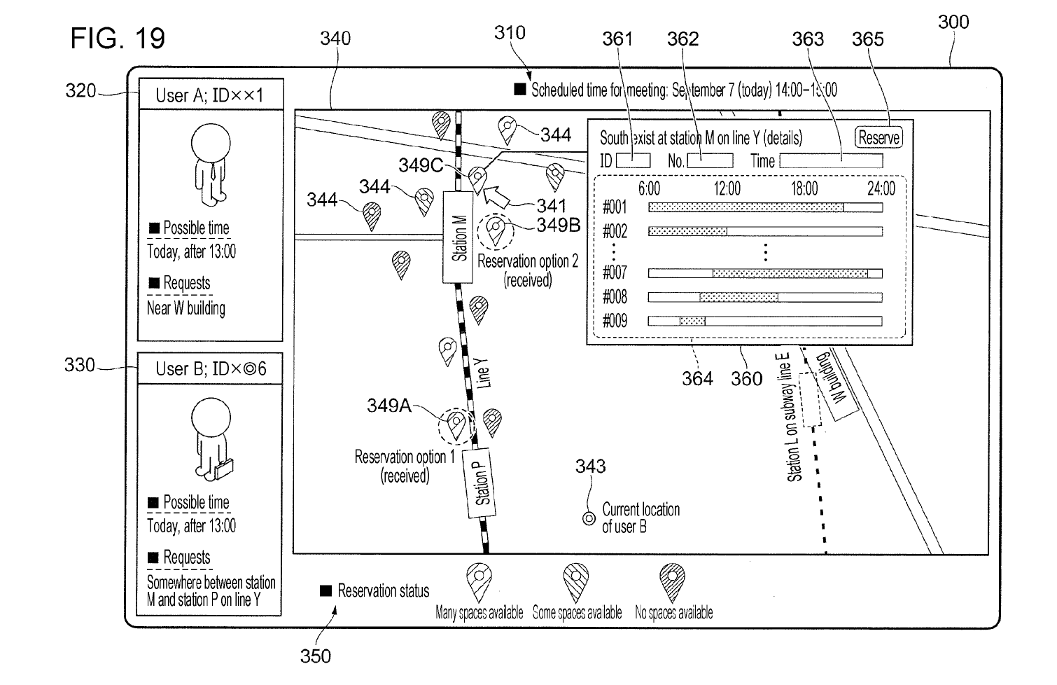

FIG. 19 illustrates an example of a case in which multiple spaces 3 are reserved for one subject user.

In FIG. 19, portions corresponding to those shown in FIG. 11 are designated by like reference numerals. In the example in FIG. 19, a reservation for subject user B is made. When making a reservation, priority is given to finding a space 3 and reserving it. There may be a case however in which, after a certain space 3 is reserved, an operator still wishes to find another space 3 which may be more convenient for a subject user.

In the example in FIG. 19, spaces 3 in two locations 349A and 349B are first reserved, and then, a space 3 in another location 349C is reserved.

The space 3 in the location 349A is reserved first and is thus indicated as reservation option 1, and the space 3 in the location 349B is reserved second and is thus indicated as reservation option 2.

In the example in FIG. 19, spaces 3 at the locations 349A and 349B are indicated as “reservation option”. This term is used when multiple spaces that match a requested time period are found and reserved for one subject user.

When only one reservation has been made for one subject user, for example, when a space 3 at the location 349A is reserved for subject user B, this space 3 is indicated as “reserved” on the screen 300. After multiple spaces 3 have been reserved for subject user B, if the reservations for the spaces 3 are all canceled by leaving a reservation for one space 3, the indication of this space 3 is changed from “reservation option” to “reserved” on the screen 300.

A space 3 indicated as “reservation option” is still a reserved space, and thus, it is not available for a reservation by another subject user.

A display example of different screens provided for individual subject users will be described below.

It is assumed that an option spot for subject user A and that for subject user B are far away from each other. In this case, if an option spot for subject user A and that for subject user B are displayed within the same region 340 (see FIG. 1), it is necessary to reduce the scale to be extremely small, and operator C may find it difficult to distinguish locations from each other and also to check the reservation statuses of spaces 3 at the locations.

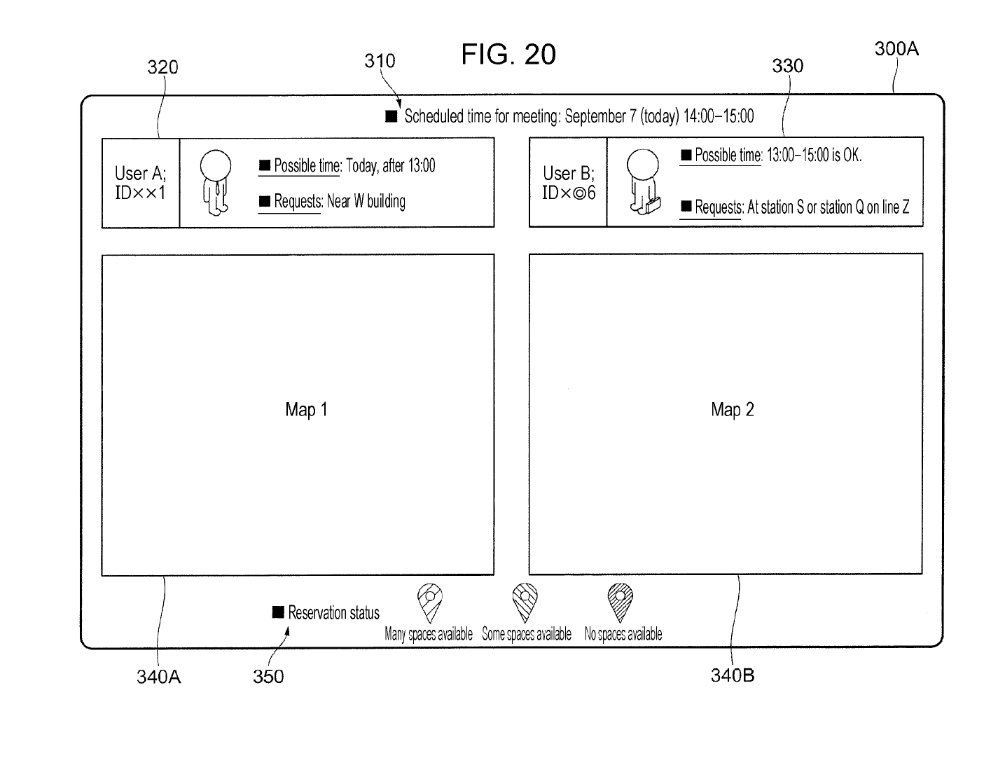

FIG. 20 illustrates a display example of a screen 300A in which reservation areas for individual subject users are displayed independently.

In FIG. 20, portions corresponding to those shown in FIG. 11 are designated by like reference numerals. In the example in FIG. 20, a region 340A is displayed in association with the region 320 in which the requests from subject user A are displayed, while a region 340B is displayed in association with the region 330 in which the requests from subject user B are displayed.

Map 1 including an option spot for subject user A is displayed in the region 340A, while map 2 including an option spot for subject user B is displayed in the region 340B. The display content of map 1 and map 2 is similar to that in the region 340 shown in FIG. 11.

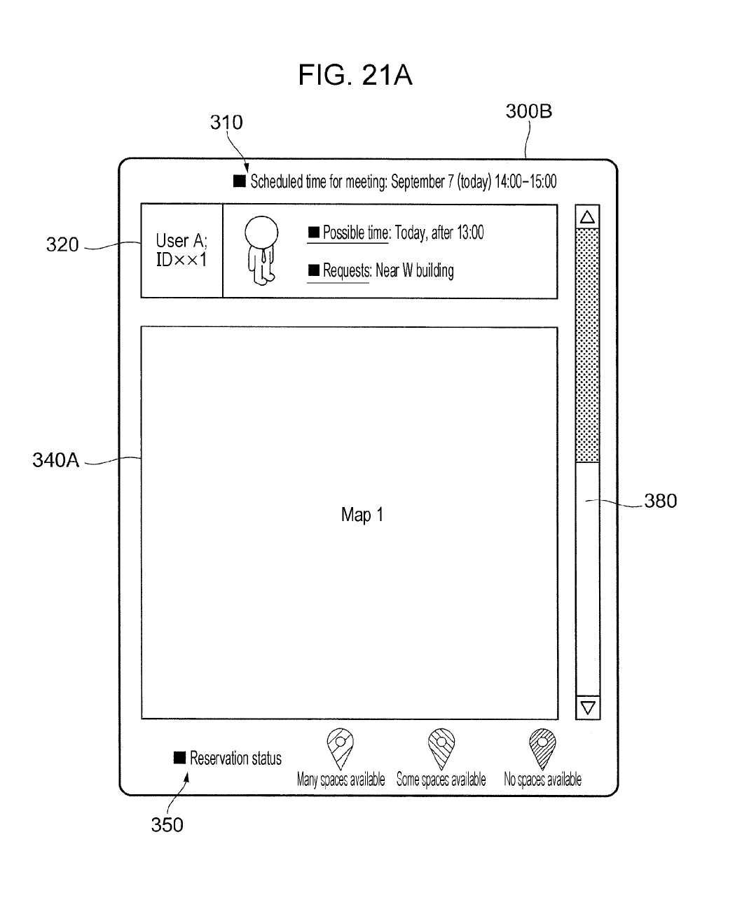

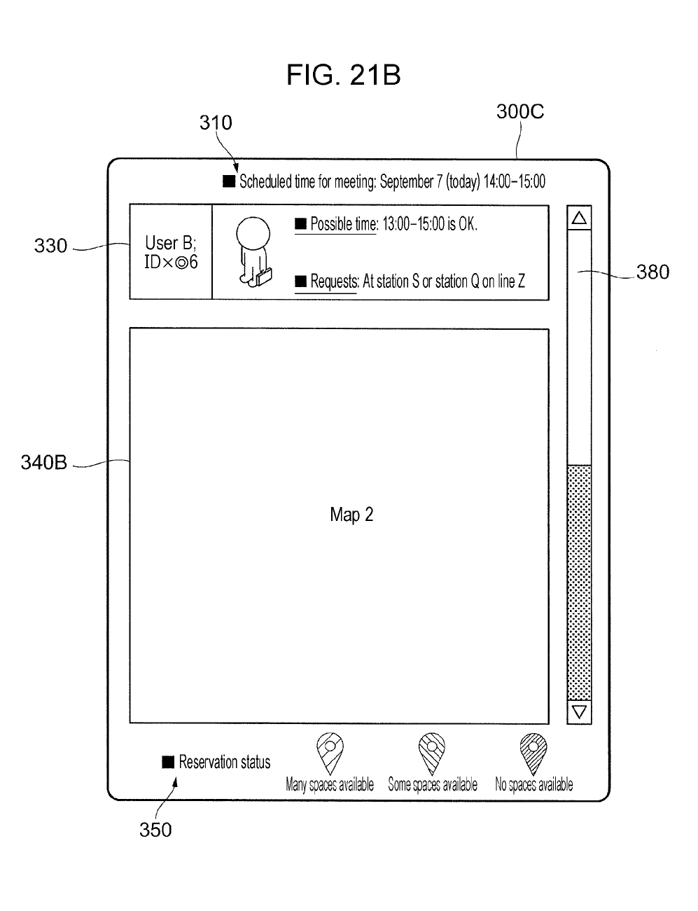

Display examples when the display screen of the user terminal 4 of operator C is small will be discussed below with reference to FIGS. 21A and 21B. In this case, a smartphone is used as the user terminal 4, for example.

FIG. 21A illustrates a display example of a screen 300B for making a reservation for subject user A. FIG. 21B illustrates a display example of a screen 300C for making a reservation for subject user B.

A scroll bar 380 is shown at the right side of each of the screens 300B and 300C to indicate the position of the displayed portion of map 1 or map 2.

The function of this exemplary embodiment allows single operator C to easily reserve multiple spaces 3 for plural subject users A and B by using one user terminal 4 (see FIG. 1).

In this case, option spots are presented on the screen 300 (see FIG. 11) according to the subject user. This enables operator C to efficiently proceed with reservation operation.

The reservation status for each option spot is indicated on the screen 300. This enables operator C to proceed with reservation operation while checking, not only the reservation status of a specific option spot, but also that of the neighboring locations.

### Other Exemplary Embodiments

The exemplary embodiment of the invention has been discussed above. However, the technical scope of the invention is not restricted to the exemplary embodiment. Various modifications and/or improvements may be made, and exemplary embodiments based on such modifications and improvements are also encompassed within the technical scope of the invention.

For example, in the above-described exemplary embodiment, among three subject users A, B, and C to attend a meeting, one of them reserves spaces 3 for the other two subject users as an operator. However, the purpose of making reservations is not limited to holding a meeting. The function of the exemplary embodiment is applicable to various cases in which one operator reserves spaces 3 for multiple subject users including the operator or without.

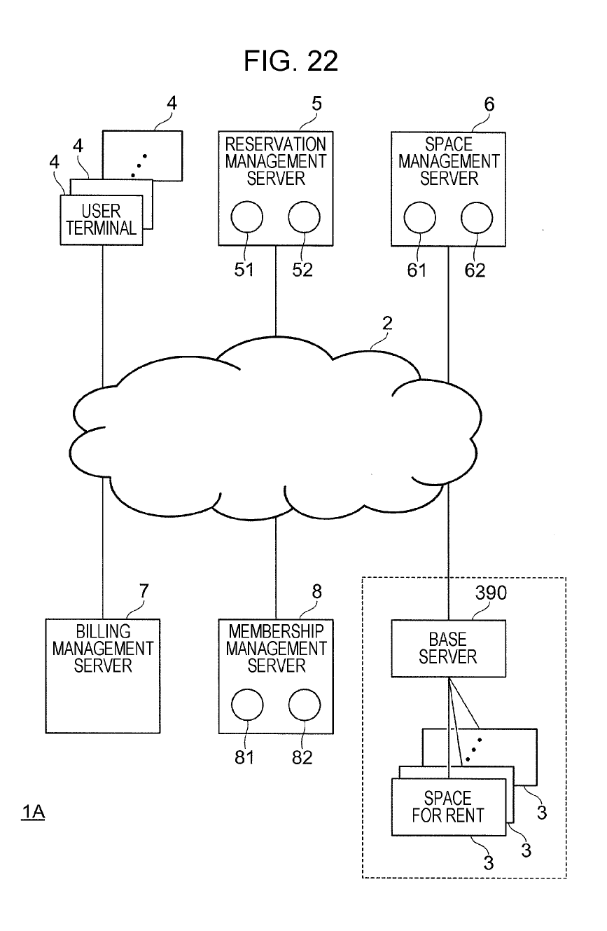

The management system 1 (see FIG. 1) is not restricted to the above-described configuration. FIG. 22 schematically illustrates another example of the configuration of the management system 1, that is, the configuration of a management system 1A. In FIG. 22, elements corresponding to those in FIG. 1 are designated by like reference numerals. The management system 1A is different from the management system 1 in that a base server 390 is used for managing the plural spaces 3. The base server 390 configured as a computer may perform the functions of the reservation controller 101 (see FIG. 6) by executing a program. In this sense, the base server 390 is an example of the apparatus.

In the above-described exemplary embodiment, a small room having a soundproof function, such as that shown in FIG. 2, is assumed as a space 3. However, meeting rooms, study rooms, and various types of guest rooms may be used as spaces 3 if reservations are required to be made for renting the spaces 3.

The above-described exemplary embodiment has been described, assuming that the door 32 can be locked. However, the above-described control function is still applicable when the door 32 is not possible to lock.

In the above-described exemplary embodiment, the spaces 3 are rented on a time basis. However, the spaces 3 may be rented based on another factor.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An apparatus comprising:
a presenter that presents options of spaces to be used by a plurality of subject users on a screen operated by an operator, the operator reserving a space for each of the subject users, an option being presented in accordance with a position linked to each of the subject users; and
a receiver that receives a reservation made for a space by the operator for each of the subject users.

2. The apparatus according to claim 1, wherein the presenter displays information concerning the position linked to each of the subject users on part of the screen.

3. The apparatus according to claim 2, wherein at least part of the position indicates a current location of a corresponding subject user.

4. The apparatus according to claim 2, wherein at least part of the position indicates a location requested by a corresponding subject user.

5. The apparatus according to claim 4, wherein the requested location is identified from a record of a conversation sent and received between the operator and the corresponding subject user.

6. The apparatus according to claim 2, wherein at least part of the position indicates a location estimated based on a schedule of a corresponding subject user.

7. The apparatus according to claim 6, wherein the location is estimated based on a route from a current location of a corresponding subject user to a destination described in a schedule of the corresponding subject user and based on a time at which a space to be used by the corresponding subject user is reserved.

8. The apparatus according to claim 1, wherein the option is a space located in a neighborhood of the position.

9. The apparatus according to claim 1, wherein the option is changeable according to a request from a corresponding subject user.

10. The apparatus according to claim 9, wherein the option is changeable according to an operation performed by the operator.

11. The apparatus according to claim 10, wherein, as the option, a plurality of reservation options are settable.

12. The apparatus according to claim 1, wherein the presenter displays reservation statuses of the options according to a difference in the color.

13. The apparatus according to claim 1, wherein the presenter displays reservation statuses of individual locations according to a difference in the color.

14. The apparatus according to claim 13, wherein, when one of the locations is selected, the presenter individually displays reservation statuses of a plurality of spaces disposed at the selected location.

15. The apparatus according to claim 12, wherein the reservation status is displayed on a corresponding position on a map.

16. The apparatus according to claim 1, wherein the presenter selects an option based on at least one of a time to be taken for a corresponding subject user to reach a space presented as an option and a time requested by the corresponding subject user.

17. The apparatus according to claim 1, wherein the operator is one of the plurality of subject users.

18. The apparatus according to claim 1, wherein information for assisting a corresponding subject user in reaching a space reserved by the operator is sent to the corresponding subject user.

19. A management system comprising:
a database in which management data concerning spaces is stored;
a presenter that presents options of the spaces to be used by a plurality of subject users on a screen operated by an operator, the operator reserving a space for each of the subject users, an option being presented in accordance with a position linked to each of the subject users; and
a receiver that receives a reservation made for a space by the operator for each of the subject users.

20. A non-transitory computer readable medium storing a program causing a computer to execute a process, the process comprising:
presenting options of spaces to be used by a plurality of subject users on a screen operated by an operator, the operator reserving a space for each of the subject users, an option being presented in accordance with a position linked to each of the subject users; and
receiving a reservation made for a space by the operator for each of the subject users.
